(19) United States
(12) Patent Application Publication
(10) Pub. No.: US 2022/0118749 A1
(43) Pub. Date: Apr. 21, 2022

(54) Sound-Insulating Material and Sound-Absorbing Material

(71) Applicants: Hyundai Motor Company, Seoul (KR); Kia Motors Corporation, Seoul (KR)

(72) Inventors: Seong Je Kim, Seongnam-si (KR); Ji Wan Kim, Hwaseong-si (KR); Jung Wook Lee, Bucheon-si (KR); Keun Young Kim, Suwon-si (KR)

(21) Appl. No.: 17/217,844

(22) Filed: Mar. 30, 2021

(30) Foreign Application Priority Data
Oct. 16, 2020 (KR) 10-2020-0134213

(51) Int. Cl. B32B 27/32; B32B 27/08; B32B 27/20; B32B 5/16; B32B 5/02

(52) U.S. Cl. CPC B32B 27/32; B32B 27/08; B32B 27/20; B32B 5/16; B32B 5/02; B32B 2274/00; B32B 2605/08; B32B 2307/102; B32B 2307/732; B32B 2264/301; B32B 2264/302; B32B 2264/303; B32B 2264/1054; B32B 2307/30

(57) ABSTRACT

A sound-insulating material includes 16 to 24% by weight of a base resin having a thermoplastic olefin (TPO) and a polyolefin elastomer (POE) and 76 to 84% by weight of an inorganic filler. The sound-insulating material can be used, for example, as part of a sound-absorbing and sound-insulating material in a vehicle.

### CROSS-REFERENCE TO RELATED APPLICATIONS

This application claims priority to Korean Patent Application No. 10-2020-0134213, filed on Oct. 16, 2020, which application is hereby incorporated herein by reference.

### TECHNICAL FIELD

The present invention relates to a sound-insulating material and a sound-absorbing material.

### BACKGROUND

In order to reduce noise generated in the engine room of vehicles, inner dash parts (dash iso-pads) are applied to the interior of the vehicle bodies. The inner dash parts are mounted into the vehicle bodies and are applied in a multi-layered structure to efficiently reduce noise. In general, the configuration of the material is divided into a hard layer and a soft layer, and urethane foam is applied to the soft layer. The configuration of the hard layer is also composed of a single layer of sound-insulating material, and is usually composed of a composite layer in order to improve noise reduction.

Conventionally, the focus has been on the characteristics of a single material. Among the composite layer that may be included in the hard layer, a high-stiffness PET layer has been developed, leading to a change in the shape of yarn and improving sound absorption performance, but causing problems of increased cost and deteriorated sound absorption performance when the thickness of the sound-insulating material in the composite layer increases. Meanwhile, a soft layer has been developed, thus reducing the weight of the parts, but leading to a disadvantage of unsatisfactory improvement in sound absorbance performance and sound insulation performance of the parts.

In addition, the conventional technology has been developed without consideration of the thickness factor of each layer in the sound-absorbing and sound-insulating material having a multilayer structure. In particular, in the case of a sound-absorbing layer, the characteristics and weight of the yarn itself are important, but the thickness thereof is also a very important factor. Specifically, the thickness of the sound-absorbing layer is affected by the thickness of the sound-insulating layer, and as the thickness of the sound-absorbing material increases, the thickness of the sound-absorbing layer decreases and the sound absorption performance decreases. Therefore, in an approach to increase the thickness of the sound-absorbing layer, the overall thickness of the part may be increased. However, it is not easy to increase the thickness of the part by varying the vehicle layout. Another approach is to reduce the thickness of the sound-insulating material. When the thickness of the sound-insulating material is reduced, the weight of the sound-insulating material is decreased, resulting in a decrease in sound insulation performance.

Therefore, in order to develop a novel sound-absorbing and sound-insulating material that is capable of improving both sound absorption performance and sound insulation performance, there is urgent need to introduce mixing of a new sound-absorbing material and to develop a multi-layered structure of a sound-absorbing and sound-insulating material including the same.

Korean Patent No. 10-1411398 discloses subject matter related to the subject matter discussed herein.

The above information disclosed in this Background section is only for enhancement of understanding of the background of the invention, and therefore it may contain information that does not form the prior art that is already known in this country to a person of ordinary skill in the art.

### SUMMARY

Embodiments of the present invention can solve above-described problems associated with the prior art.

For example, embodiments provide a sound-insulating material having increased specific gravity to maintain the performance of the sound-insulating material while reducing the thickness thereof, so as to improve sound absorbance performance by increasing the thickness of a sound-absorbing layer in a sound-absorbing and sound-insulating material.

As another example, embodiments provide a sound-absorbing and sound-insulating material including the sound-absorbing material described above and thus to impart increased thickness to a sound-absorbing layer and thereby secure improved sound absorption performance as well as sound absorption performance, and an isolation pad, tunnel pad, or floor carpet manufactured therefrom.

Advantages are not limited to those described above. The various embodiments will be clearly understood from the following description and could be implemented by means defined in the claims and a combination thereof.

In one aspect, the present invention provides a sound-insulating material including 16 to 24% by weight of a base resin including a thermoplastic olefin (TPO) and a polyolefin elastomer (POE), and 76 to 84% by weight of an inorganic filler.

The base resin may include 11 to 16% by weight of the TPO and 5 to 8% by weight of the POE, based on the total weight of the sound-insulating material.

The TPO may have a melt index (MI) of 5 to 25 g/10 minutes.

The TPO may include at least one selected from the group consisting of low-density polyethylene (LDPE), linear low-density polyethylene (LLDPE), high-density polyethylene (HDPE), ethylene vinyl acetate (EVA), and ethylene propylene rubber (EPM, EPDM).

The POE may have a melt index (MI) of 25 to 35 g/10 minutes.

The POE may include at least one selected from the group consisting of an ethylene-butene copolymer and an ethylene-octene copolymer.

The inorganic filler may include barium sulfide (BaSO₄).

The inorganic filler may have a particle diameter of 5 μm or less.

The sound-insulating material may have a specific gravity of 2.5 or more.

In another aspect, the present invention provides a sound-absorbing and sound-insulating material including a hard layer including a sound-insulating layer including the sound-insulating material and a fibrous layer disposed on one surface of the sound-insulating layer, and a soft layer disposed on the other surface of the sound-insulating layer.

The fibrous layer may have a thickness of 2.5 to 5 mm and a specific gravity of 800 to 1400 g/cm².

In another aspect, the present invention provides a dash isolation pad, a tunnel pad, or floor carpet including the sound-absorbing and sound-insulating material.

Other aspects and preferred embodiments of the invention are discussed infra.

### BRIEF DESCRIPTION OF THE DRAWINGS

The above and other features of the present invention will now be described in detail with reference to certain exemplary embodiments thereof, illustrated in the accompanying drawings which are given hereinbelow by way of illustration only, and thus are not limitative of the present invention, and wherein:

FIG. 1A is a graph showing the results of evaluating the sound absorbance performance of the sound-absorbing and sound-insulating materials produced according to Example 2 of the present invention, Comparative Example 2-1, and Comparative Example 2-2;

FIG. 1B is a graph showing the results of evaluating the sound insulation performance of the sound-absorbing and sound-insulating materials produced according to Example 2 of the present invention, Comparative Example 2-1, and Comparative Example 2-2;

FIG. 2A is a graph showing the results of evaluating the sound absorption performance of the dash isolation pads produced according to Example 3 of the present invention and Comparative Example 3;

FIG. 2B is a graph showing the results of evaluating the sound insulation performance of the dash isolation pads produced according to Example 3 of the present invention and Comparative Example 3;

FIG. 3A is a graph showing the results of evaluating the sound absorption performance of the dash isolation pads produced according to Example 4 of the present invention and Comparative Example 3; and

FIG. 3B is a graph showing the results of evaluating the sound insulation performance of the dash isolation pads produced according to Example 4 of the present invention and Comparative Example 3.

### DETAILED DESCRIPTION OF ILLUSTRATIVE EMBODIMENTS

Features and advantages will be clearly understood from the following embodiments with reference to the attached drawings. However, the present invention is not limited to the embodiments and may be embodied in different forms. The embodiments are suggested only to offer a thorough and complete understanding of the disclosed context and to sufficiently inform those skilled in the art of the technical concept of the present invention.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous and include all numbers from the minimum to the maximum, including the maximum within each range, unless otherwise defined. Furthermore, when the range refers to an integer, it includes all integers from the minimum to the maximum including the maximum within the range, unless otherwise defined.

It should be understood that, in the specification, when a range is referred to regarding a parameter, the parameter encompasses all figures including end points disclosed within the range. For example, the range of “5 to 10” includes values of 5, 6, 7, 8, 9, and 10, as well as arbitrary sub-ranges, such as ranges of 6 to 10, 7 to 10, 6 to 9, and 7 to 9, and any values, such as 5.5, 6.5, 7.5, 5.5 to 8.5 and 6.5 to 9, between appropriate integers that fall within the range. In addition, for example, the range of “10% to 30%” encompasses all integers that include numbers such as 10%, 11%, 12% and 13% as well as 30%, and any sub-ranges, such as ranges of 10% to 15%, 12% to 18%, or 20% to 30%, as well as any numbers, such as 10.5%, 15.5% and 25.5%, between appropriate integers that fall within the range.

Conventionally, without consideration of the thickness factor of each layer in the sound-absorbing and sound-insulating material having a multilayer structure, components in the multilayer structure have been developed to improve sound-absorbing and sound-insulating properties. Accordingly, the present inventors have made research on methods of increasing the thickness of the sound-absorbing layer in order to improve the sound-absorbing property. As a result, a sound-insulating material that can maintain sound insulation performance by increasing the specific gravity while reducing the thickness by more than 1 mm compared to the prior art has been developed, because, when the thickness of the sound-insulating material is reduced, sound insulation performance may be deteriorated due to the decreased weight of the sound-insulating material. Specifically, the sound-insulating material according to the prior art requires a specific gravity of 1.5. An increase in an inorganic material content is required in order to increase the specific gravity, but there is a limit to increasing the specific gravity simply by increasing the conventional CaCO₃ content. In addition, when the content of inorganic material is simply increased in the conventional mixing ratio, cracks may form and it is difficult to realize a specific gravity of 2.0 or more. Accordingly, as a result of intensive research in order to solve the above problems, the present inventors completed the present invention by developing a sound-absorbing material produced by mixing a base resin having specific components in specific amounts with a new inorganic material having a specific content and specifications, instead of the conventional inorganic CaCO₃, in order to increase the specific gravity while reducing the thickness by 1 mm or more.

The sound-insulating material according to an embodiment of the present invention includes a base resin including a thermoplastic olefin (TPO) and a polyolefin elastomer (POE), and an inorganic filler. Preferably, the sound-insulating material includes 16 to 24% by weight of the base resin including the thermoplastic olefin (TPO) and the polyolefin elastomer (POE), and 76 to 84% by weight of the inorganic filler.

The base resin according to an embodiment of the present invention includes the thermoplastic olefin (TPO) and the polyolefin elastomer (POE), and any base resin may be used without particular limitation so long as it can properly disperse the inorganic filler used to increase the specific gravity of the sound-insulating material including the base resin and maintain the physical properties of the sound-insulating material.

The thermoplastic olefin (TPO) contained in the base resin according to the present invention may include TPO that can be used in the present invention, for example, at least one selected from the group consisting of polyolefins including low-density polyethylene (LDPE), linear low-density polyethylene (LLDPE), high-density polyethylene (HDPE) ethylene vinyl acetate (EVA) and ethylene propylene rubber (EPM, EPDM). The TPO is not limited to a specific component, but preferably includes LLDPE and EPDM, having excellent productivity and moldability.

The polyolefin elastomer (POE) contained in the base resin according to the present invention may include POE that can be used in the present invention, for example, at least one selected from the group consisting of an ethylene-butene copolymer and an ethylene-octene. The POE is not limited to a specific component, but preferably includes an ethylene-octene copolymer having excellent moldability owing to good flowability.

The base resin according to an embodiment of the present invention may include 11 to 16% by weight of the TPO and 5 to 8% by weight of the POE, based on the total weight of the sound-insulating material. When the content of TPO is less than 11% by weight or the content of POE is less than 5% by weight, it is difficult to secure the physical properties of the final sound-absorbing and sound-insulating material, and when the content of TPO exceeds 16% by weight or the content of POE exceeds 8% by weight, the relative content of the inorganic filler decreases and thus the specific gravity may decrease. Accordingly, the base resin according to the present invention preferably includes 16 to 24% by weight of the thermoplastic olefin (TPO) and the polyolefin elastomer (POE), based on the total weight of the sound-insulating material.

Regarding the melt index (MI) of the base resin according to an embodiment of the present invention, specifically, the melt index (MI) of the TPO may be 15 to 25 g/10 minutes, and the melt index (MI) of the POE may be 25 to 35 g/10 minutes in order to improve productivity of the sound-insulating material, and maintain and reinforce the physical properties thereof despite increasing the content of the inorganic filler to increase the specific gravity of the sound-insulating material including the same and decreasing the particle size of the inorganic filler to improve dispersibility. When the MI of the TPO is less than 15 g/10 minutes or the MI of the POE is less than 25 g/10 minutes, the dispersibility of the inorganic filler is lowered, so cracks may form in the surface of the sound-insulating material including the same, and when the MI of the TPO exceeds 25 g/10 minutes or the MI of POE exceeds 35 g/10 minutes, it is disadvantageously difficult to maintain the shape of the part due to deterioration in the overall physical properties of the sound-insulating material including the same.

That is, the base resin in the sound-insulating material according to an embodiment of the present invention is prepared using TPO and POE having certain properties such as a certain mixing ratio and melt index (MI), so the specific gravity can be increased to 2.5 or more and thus the thickness of the sound-absorbing layer in the sound-absorbing and sound-insulating material including the same can be increased, the weight and manufacturing costs are reduced compared to conventional parts, and both the sound insulation performance and the sound absorption performance can be improved.

The inorganic filler according to an embodiment of the present invention is not particularly limited, so long as it does not cause cracks by securing dispersibility in the base resin while exhibiting physical properties for securing a high specific gravity of the sound-insulating material including the same.

The inorganic filler according to an embodiment of the present invention may include at least one selected from the group consisting of conventional inorganic fillers that can be used in the present invention, for example, barium sulfide (BaSO₄), calcium carbonate, talc, clay, silica, mica, iron oxide, kaolin clay, silicic acid powder, wollastonite, magnesium oxide, diatomaceous earth, sepiolite, aluminum oxide and ferrite, and is not limited to a specific component, but preferably includes barium sulfide (BaSO₄), which can reduce the incidence of cracks and improve the specific gravity of the sound-insulating material including the same because cracks may form in the sound-insulating material including the same when the content of the inorganic filler is simply increased in the conventional mixing, and it is difficult to secure a specific gravity of 2.0 or more.

The content of the inorganic filler according to an embodiment of the present invention may be 76 to 84% by weight based on the total weight of the sound-insulating material. When the content of the inorganic filler is less than 76% by weight, it is difficult to secure the specific gravity of the sound-insulating material, and when the content of the inorganic filler exceeds 84% by weight, the dispersibility of the inorganic filler decreases, disadvantageously causing cracks on the surface of the sound-insulating material including the inorganic filler.

The particle diameter of the inorganic filler according to an embodiment of the present invention may be 5 μm or less, and preferably 1 to 5 μm. When the particle diameter of the inorganic filler is less than 1 μm or is greater than 5 μm, disadvantageously, the dispersibility of the inorganic filler is deteriorated and cracks may form in the surface of the sound-insulating material including the inorganic filler.

That is, the inorganic filler in the sound-insulating material according to an embodiment of the present invention is produced to have certain characteristics such as a certain mixing ratio and a certain particle diameter range, so the specific gravity can be increased to 2.5 or more, and the thickness of the sound-absorbing layer in the sound-absorbing and sound-insulating material including the same can be increased, the weight and manufacturing costs are reduced compared to conventional parts, and both the sound insulation performance and the sound absorption performance can be improved.

Sound-absorbing and sound-insulating material will now be discussed.

The sound-absorbing and sound-insulating material according to an embodiment of the present invention includes a hard layer including a sound-insulating layer including the sound-insulating material and a fibrous layer disposed on one surface of the sound-insulating layer, and a soft layer disposed on the other surface of the sound-insulating layer.

The soft layer according to an embodiment of the present invention is not particularly limited, so long as it is disposed on the other surface of the sound-insulating layer and can serve as a sound-absorbing layer. The soft layer according to an embodiment of the present invention may include an ordinary layer that can be used in the present invention, for example, PU foam, polyethylene fiber, polypropylene fiber, miscellaneous yarn felt, or resin felt, and is limited to a specific material, but preferably includes a PU foam having excellent sound-absorption performance and sound-insulation performance and superior compatibility with parts.

The sound-insulating material included in the sound-insulating layer in the sound-absorbing and sound-insulating material according to an embodiment of the present invention may be the same as or different from that described above. That is, the sound-insulating layer according to an embodiment of the present invention has the characteristics described above, thereby increasing the specific gravity to 1.5 to 2.5 and reducing the thickness to 1.5 to 2.5 mm, so the specific gravity is increased while the thickness is reduced. As a result, the thickness of the sound-absorbing layer in the sound-absorbing and sound-insulating material including the same can be increased, weight and manufacturing costs are reduced compared to conventional parts, and both the sound insulation performance and the sound absorption performance can be improved.

The fibrous layer according to an embodiment of the present invention is not particularly limited, so long as it is present in the hard layer of the sound-absorbing and sound-insulating material and can serve as a sound-absorbing layer. The fibrous layer according to an embodiment of the present invention may include a conventional fibrous layer that can be used in the present invention, for example, PET fiber, PP fiber, nylon fiber or miscellaneous yarn felt, but is not limited to a specific fiber, and preferably includes PET fiber, having excellent heat resistance and part moldability.

The fibrous layer according to an embodiment of the present invention can have increased thickness and decreased specific gravity compared to the prior art due to the decreased thickness and increased specific gravity of the sound-insulating layer. Specifically, the thickness of the fibrous layer may be 2.5 to 5 mm, and the specific gravity of the fibrous layer may be 800 to 1,400 g/cm². That is, the sound-absorbing and sound-insulating material according to an embodiment of the present invention can reduce the specific gravity of the sound-absorbing layer in the sound-absorbing and sound-insulating material while increasing the thickness thereof compared to the prior art due to the decreased thickness and increased specific gravity of the sound-insulating layer included therein, thus advantageously improving sound insulation performance and sound absorption performance while reducing weight and manufacturing costs compared to conventional parts.

The sound-absorbing and sound-insulating material according to an embodiment of the present invention that satisfies the characteristics described above may be applied to all parts applied by being mounted on a vehicle body, for example, any part having a large area or a small area such as a dash isolation pad, a tunnel pad or a floor carpet. As a result, the sound-absorbing and sound-insulating material has the advantage of providing a pleasant environment for consumers by improving the performance of the NVH (noise, vibration and harshness) of the vehicle.

Hereinafter, the present invention will be described in more detail with reference to specific examples. However, the following examples are provided only for illustration of the present invention, and thus should not be construed as limiting the scope of the present invention.

### Example 1: Sound-Insulating Material Satisfying Contents and Characteristics of Present Invention

A sound-insulating material according to an embodiment of the present invention was produced. Specifically, a base resin was prepared as follows. That is, 15% by weight of LLDPE and EPDM (melt index (MI) of 15 g/10 min) as a thermoplastic olefin (TPO) and 5% by weight of an ethylene-octene copolymer (melt index (MI) of 30 g/10 min) as a polyolefin elastomer (POE) were prepared. In addition, 80% by weight of BaSO₄ (particle size of 5 μm) was prepared as an inorganic filler. As a result, the base resin and inorganic filler having the content and characteristics described above were mixed, and then a sound-insulating material was produced by a T-die extrusion method (temperature of 180° C.).

### Comparative Examples 1-1 to 1-4: Sound-Insulating Materials Deviating from Characteristics of Present Invention

When compared with Example 1, in Comparative Example 1-1, 18 to 24% by weight of LLDPE and EPDM as a TPO (melt index (MI) of 5 g/10 min) and 12 to 18% by weight of an ethylene-octene copolymer (melt index (MI) of 17 g/10 min) as a polyolefin elastomer (POE) in a base resin was prepared. In addition, a sound-insulating material was produced in the same manner as in Example 1, except that 58 to 63% by weight of CaCO₃ was prepared as an inorganic filler.

When compared with Example 1, in Comparative Example 1-2, 18 to 24% by weight of LLDPE and EPDM as a TPO (melt index (MI) of 5 g/10 min) and 12 to 18% by weight of an ethylene-octene copolymer (melt index (MI) of 17 g/10 min) as a polyolefin elastomer (POE) in a base resin was prepared. In addition, a sound-insulating material was produced in the same manner as in Example 1, except that 25 to 30% by weight of CaCO₃ and 60% by weight of BaSO₄ (particle size of 23 μm) were prepared as inorganic fillers.

When compared with Example 1, in Comparative Example 1-3, 11 to 13% by weight of LLDPE and EPDM as a TPO (melt index (MI) of 5 g/10 min) and 8 to 13% by weight of an ethylene-octene copolymer (melt index (MI) of 17 g/10 min) as a polyolefin elastomer (POE) in a base resin was prepared. In addition, a sound-insulating material was produced in the same manner as in Example 1, except that 10 to 15% by weight of CaCO₃ and 70 to 75% by weight of BaSO₄ (particle size of 23 μm) were prepared as inorganic fillers.

When compared with Example 1, in Comparative Example 1-4, 9 to 11% by weight of LLDPE and EPDM as a TPO (melt index (MI) of 5 g/10 min) and 10 to 15% by weight of an ethylene-octene copolymer (melt index (MI) of 17 g/10 min) as a polyolefin elastomer (POE) in a base resin was prepared. In addition, a sound-insulating material was produced in the same manner as in Example 1, except that 80% by weight of BaSO₄ (particle size of 5 μm) was prepared as an inorganic filler.

### Example 2 and Comparative Example 2-1 to Comparative Example 2-2: Sound-Absorbing and Sound-Insulating Material Including Sound-Insulating Material

The sound-insulating layer including the sound-insulating material of Example 1 was hot-pressed to obtain a hard layer having a predetermined thickness under the conditions shown in Table 1 below, and then PU foam molding was conducted thereon to manufacture a sound-absorbing and sound-insulating material.

TABLE 1

| | | | Comparative | Comparative |
|---|---|---|---|---|
| Item | | Example 2 | Example 2-1 | Example 2-2 |
| Hard | Fibrous | PET 1200 g/m², | PET 1200 g/m², | PET 1200 g/m², |
| layer | layer | 3.5 mm | 2.5 mm | 2.5 mm |
| | Sound- | TPE specific | TPE specific | TPE specific |
| | insulating | gravity 2.5, | gravity 2.5, | gravity 1.5, |
| | layer | 1.5 mm | 1.5 mm | 2.5 mm |

| | | | |
|---|---|---|---|
| Soft layer | PU85K, 20 mm | PU85K, 21 mm | PU85K, 20 mm |
| (PU foam) | | | |

### Examples 3 to 4 and Comparative Example 3: Dash Isolation Pad Including Sound-Absorbing and Sound-Insulating Material

The sound-insulating layer including the sound-insulating material of Example 1 was hot-pressed to obtain a hard layer with a predetermined thickness under the conditions shown in Table 2 below and then PU foam molding was conducted thereon to manufacture a dash isolation pad including a sound-absorbing and sound-insulating material.

TABLE 2

| | | | | Comparative |
|---|---|---|---|---|
| Item | | Example 3 | Example 4 | Example 3 |
| Hard | Fibrous | PET 1400 g/m², | PET 1000 g/m², | PET 1400 g/ |
| layer | layer | 3.5 mm | 3.5 mm | m², 2.5 mm |
| | Sound- | TPE specific | TPE specific | TPE specific |
| | insulating | gravity 2.5, | gravity 2.5, | gravity 1.5, |
| | layer | 1.5 mm | 1.5 mm | 2.5 mm |

| | | | |
|---|---|---|---|
| Soft layer | PU85K, | PU85K, | PU85K, |
| (PU foam) | 20 mm | 20 mm | 20 mm |

Methods for evaluating physical properties of the materials will now be described.

In the method for evaluating sound absorption performance a test specimen or part with a size of 0.84 m×0.84 m was loaded in a chamber, 15 sound sources from 400 Hz to 10,000 Hz were input, and the sound absorption coefficient of the material in response to the reverberation was measured and compared (ISO 354).

In a method for evaluating sound insulation performance a plate specimen with a size of 0.84 m×0.84 m was loaded in a chamber, 200 steel balls were excited by a roller, and transmission loss at 100 Hz to 10 kHz was measured and compared.

### Experimental Example 1: Comparison of Physical Properties According to Characteristics of Components in Sound-Insulating Material

The specific gravity and physical properties of the surface of the sound-insulating materials produced according to Example 1 and Comparative Examples 1-1 to 1-4 were measured, and the results are shown in Table 3 below.

TABLE 3

| | Specific | Physical properties |
|---|---|---|
| Item | gravity | Surface |
| Example 1 | 2.53 | Good |
| Comparative Example 1-1 | 1.5 | Good |
| Comparative Example 1-2 | 2.2 | Good |
| Comparative Example 1-3 | 2.4 | Good |
| Comparative Example 1-4 | 2.45 | Surface crack |

As can be seen from Table 3, the sound-insulating material according to Example 1, which satisfies the content of the base resin and BaSO₄ as an inorganic filler according to an embodiment of the present invention, has a high specific gravity and excellent sound-insulating material surface. On the other hand, the sound-insulating material, which does not satisfy the content of the base resin according to an embodiment of the present invention and contains CaCO₃ instead of BaSO₄ (Comparative Example 1-1), or contains both BaSO₄ and CaCO₃ (Comparative Example 1-2, and Comparative Example 1-3) has good surface properties, but relatively low specific gravity. In addition, it can be seen that in the sound-insulating material manufactured without the specific content of the base resin, despite satisfying all the conditions of the inorganic filler according to an embodiment of the present invention, has a relatively low specific gravity, but a cracked surface. That is, the sound-insulating material according to an embodiment of the present invention is manufactured at a certain mixing ratio, so the specific gravity can be increased while the thickness is reduced, and as a result, the thickness of the sound-insulating layer in the sound-absorbing and sound-insulating material including the same can be increased while reducing the specific gravity.

### Experimental Example 2: Evaluation of Flat Plate when Controlling Thickness of Fibrous Layer or Soft Layer, as Sound-Insulating Layer in Sound-Absorbing and Sound-Insulating Material

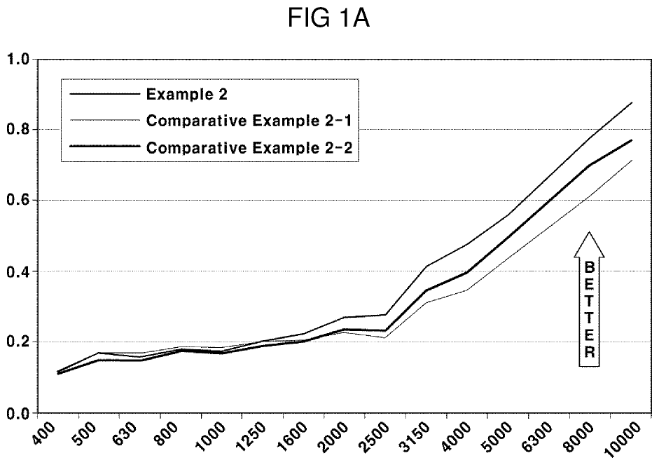

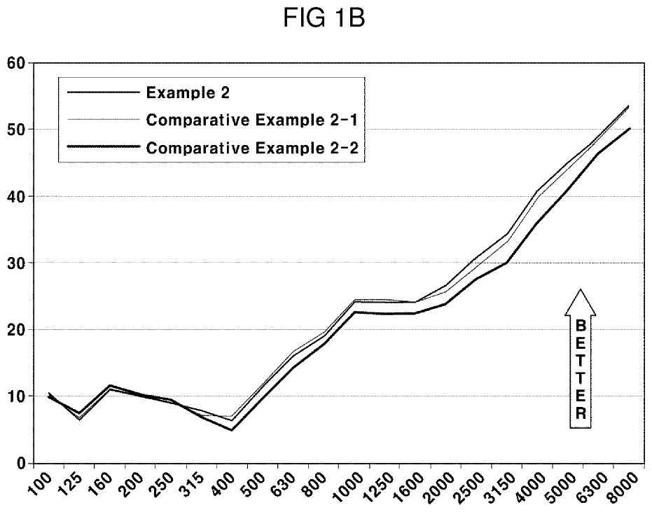

The weight, sound absorption performance and sound insulation performance of the sound-absorbing and sound-insulating materials manufactured according to Example 2, Comparative Example 2-1 and Comparative Example 2-2 were measured and the results are shown in Table 4 below and in FIGS. 1A and 1B.

TABLE 4

| | Example | Comparative | Comparative |
|---|---|---|---|
| Item | 2 | Example 2-1 | Example 2-2 |
| Weight (g/m²) | 4,692 | 4,952 | 4,692 |
| sound absorption | 0.37 | 0.31 | 0.33 |
| performance | | | |
| (Mean sound- | | | |
| absorbing proportion) | | | |
| Sound insulation | 51.0 | 50.4 | 48.1 |
| performance | | | |
| (IL, dB) | | | |

As can be seen from Table 4 and FIGS. 1A and 1B, Example 2, in which the thickness of the fibrous layer is increased by 1 mm compared to Comparative Example 2-2, which is a conventional sound-absorbing and sound-insulating material, exhibits excellent sound absorption performance and sound insulation performance while maintaining the same weight. On the other hand, it can be seen that Example 2, in which the thickness of the soft layer was increased by 1 mm compared to Comparative Example 2-2, which is a conventional sound-absorbing and sound-insulating material, exhibits low sound absorption performance despite being heavy. The sound-absorbing and sound-insulating material manufactured according to Comparative Example 2-2 has a disadvantage in that the thickness of the hard layer changes as the thickness of the soft layer increases, so that mold modification is required, and the weight and manufacturing costs increase due to the increase in the use of PU foam contained in the soft layer. On the other hand, the sound-absorbing and sound-insulating material manufactured according to Example 2 does not require mold modification due to the constant thickness of the hard layer including the fibrous layer and the sound insulating layer. Therefore, the sound-absorbing and sound-insulating material according to the present invention manufactured by adjusting the thickness of the fibrous layer has the advantage of improving sound absorption performance and sound insulation performance while reducing weight and manufacturing costs compared to conventional parts.

### Experimental Example 3: Evaluation of Parts of Dash Isolation Pad Produced Using Sound-Absorbing and Sound-Insulating Material

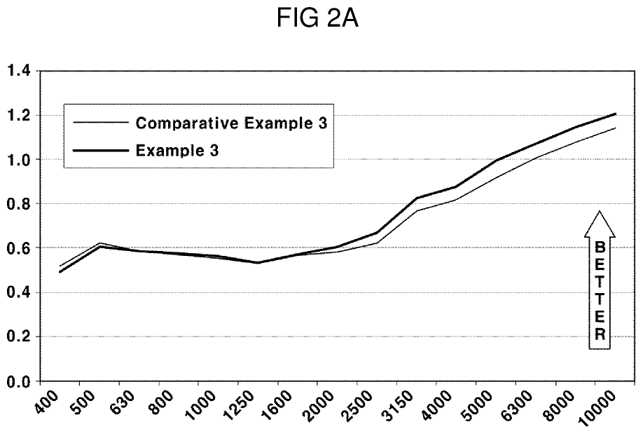

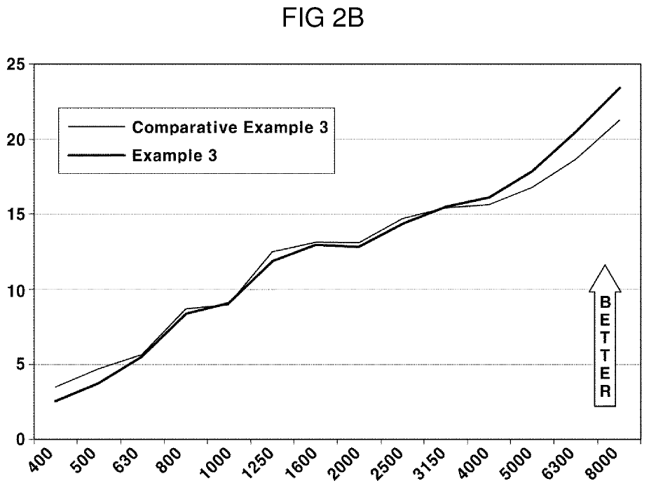

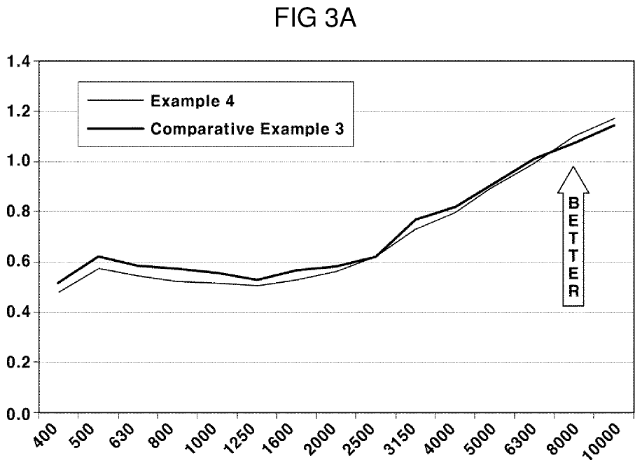

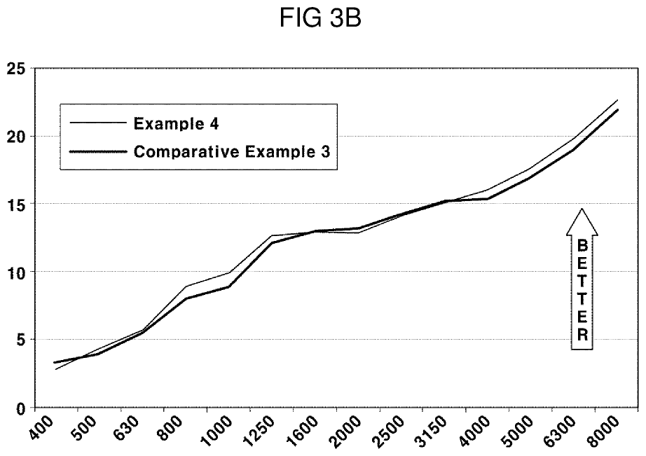

The weight, sound absorption performance and sound insulation performance of the dash isolation pads manufactured according to Examples 3 and 4, and Comparative Example 3 were measured, and the results are shown in Table 5 below and in FIGS. 2A to 3B.

TABLE 5

| | Example | Example | Comparative |
|---|---|---|---|
| Item | 3 | 4 | Example 3 |
| Weight (g/m²) | 5,150 | 4,750 | 5,150 |
| Sound absorption | 0.93 | 0.86 | 0.87 |
| performance | | | |
| (Mean sound- | | | |
| absorbing | | | |
| proportion) | | | |
| Sound insulation | 27.6 | 27.1 | 26.4 |
| performance | | | |
| (IL, dB) | | | |

As can be seen from Table 5 and FIGS. 2A and 2B, the dash isolation pad of Example 3 manufactured with the sound-absorbing and sound-insulating material according to the present invention exhibits superior sound absorption performance and sound insulation performance than the dash isolation pad of Comparative Example 3, manufactured according to the prior art, at the same thickness and weight. In addition, as can be seen from Table 5 and FIGS. 3A and 3B, the dash isolation pad of Example 4 manufactured using the sound-absorbing and sound-insulating material according to the present invention (in which the specific gravity of the fibrous layer is reduced by 400 g/m² compared to Example 3), exhibits sound absorption performance and sound insulation performance comparable to or superior to the dash isolation pad of Comparative Example 3, manufactured using the conventional sound-insulating material, although the specific gravity of the fibrous layer was reduced by about 400 g/m² compared to Example 3. That is, the sound-insulating material according to an embodiment of the present invention is manufactured at a certain mixing ratio and thus has advantages of increased specific gravity and reduced thickness, thereby increasing the thickness of the sound-absorbing layer in the sound-absorbing and sound-insulating material including the same while reducing the specific weight, and improving both the sound insulation performance and the sound absorption performance while reducing the weight and manufacturing costs compared to conventional parts. Accordingly, the sound-absorbing and sound-insulating material according to the present invention can be applied to a dash isolation pad, a tunnel pad or floor carpet, so consumers' comfort can be satisfied through improvement of NVH (noise, vibration, harshness) performance of the vehicle.

As is apparent from the foregoing, the present invention provides a sound-insulating material with improved sound insulation performance and a sound-absorbing and sound-insulating material with a multilayer structure including the same. The sound-insulating material is manufactured at a certain mixing ratio and thus has advantages of increased specific gravity and reduced thickness, thereby increasing the thickness of the sound-absorbing layer in the sound-absorbing and sound-insulating material including the same while reducing the specific weight, and improving both the sound insulation performance and the sound absorption performance while reducing weight and manufacturing costs compared to conventional parts. Accordingly, the sound-absorbing and sound-insulating material according to the present invention can be applied to a dash isolation pad, a tunnel pad or a floor carpet, so consumers' comfort can be satisfied through improvement of NVH (noise, vibration, harshness) performance of the vehicle.

The effects of the present invention are not limited to those mentioned above. It should be understood that the effects of the present invention include all effects that can be inferred from the description of the present invention.

The present invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A sound-insulating material comprising:
16 to 24% by weight of a base resin comprising a thermoplastic olefin (TPO) and a polyolefin elastomer (POE); and
76 to 84% by weight of an inorganic filler.

2. The sound-insulating material according to claim 1, wherein the base resin comprises 11 to 16% by weight of the TPO and 5 to 8% by weight of the POE, based on a total weight of the sound-insulating material.

3. The sound-insulating material according to claim 1, wherein the TPO has a melt index (MI) of 5 to 25 g/10 minutes.

4. The sound-insulating material according to claim 1, wherein the TPO comprises a material selected from the group consisting of low-density polyethylene (LDPE), linear low-density polyethylene (LLDPE), high-density polyethylene (HDPE), ethylene vinyl acetate (EVA), ethylene propylene rubber (EPM, EPDM) and combinations thereof.

5. The sound-insulating material according to claim 1, wherein the POE has a melt index (MI) of 25 to 35 g/10 minutes.

6. The sound-insulating material according to claim 1, wherein the POE comprises a material selected from the group consisting of an ethylene-butene copolymer, an ethylene-octene copolymer and combinations thereof.

7. The sound-insulating material according to claim 1, wherein the inorganic filler comprises barium sulfide (BaSO₄).

8. The sound-insulating material according to claim 1, wherein the inorganic filler has a particle diameter of 5 μm or less.

9. The sound-insulating material according to claim 1, wherein the inorganic filler has a specific gravity of 2.5 or more.

10. A sound-absorbing and sound-insulating material comprising:
a hard layer comprising a sound-insulating layer and a fibrous layer disposed on one surface of the sound-insulating layer, the sound-insulating material comprising 16 to 24% by weight of a base resin comprising a thermoplastic olefin (TPO) and a polyolefin elastomer (POE) and 76 to 84% by weight of an inorganic filler; and
a soft layer disposed on an opposite surface of the sound-insulating layer.

11. The sound-absorbing and sound-insulating material according to claim 10, wherein the fibrous layer has a thickness of 2.5 to 5 mm.

12. The sound-absorbing and sound-insulating material according to claim 10, wherein the fibrous layer has a specific gravity of 800 to 1400 g/cm².

13. The sound-absorbing and sound-insulating material according to claim 10, wherein the sound-absorbing and sound-insulating material is part of a dash isolation pad.

14. The sound-absorbing and sound-insulating material according to claim 10, wherein the sound-absorbing and sound-insulating material is part of a tunnel pad.

15. The sound-absorbing and sound-insulating material according to claim 10, wherein the sound-absorbing and sound-insulating material is part of a floor carpet.

16. A vehicle comprising:
a vehicle body;
an engine room within the vehicle body;
an engine within the engine room;
a passenger room within the vehicle body; and
a sound-absorbing and sound-insulating material applied to an interior of the vehicle body, the sound-insulating material comprising 16 to 24% by weight of a base resin comprising a thermoplastic olefin (TPO) and a polyolefin elastomer (POE) and 76 to 84% by weight of an inorganic filler.

17. The vehicle according to claim 16, wherein the sound-absorbing and sound-insulating material is disposed between the engine room and the passenger room.

18. The vehicle according to claim 16, wherein the sound-absorbing and sound-insulating material is part of a dash isolation pad of the vehicle.

19. The vehicle according to claim 16, wherein the sound-absorbing and sound-insulating material is part of a tunnel pad of the vehicle.

20. The vehicle according to claim 16, wherein the sound-absorbing and sound-insulating material is part of a floor carpet disposed on a floor of the passenger room.
